(19) United States
(12) Patent Application Publication
(10) Pub. No.: US 2025/0360667 A1
(43) Pub. Date: Nov. 27, 2025

(54) LIFTING APPARATUS AND INJECTION MOLDING MACHINE

(71) Applicant: THE JAPAN STEEL WORKS, LTD., Tokyo (JP)

(72) Inventor: Yuta OKUTANI, Tokyo (JP)

(21) Appl. No.: 19/214,214

(22) Filed: May 21, 2025

(30) Foreign Application Priority Data
May 22, 2024 (JP) 2024-083284

(51) Int. Cl. B29C 45/50; B29C 45/07

(52) U.S. Cl. CPC B29C 45/5008; B29C 45/07

(57) ABSTRACT

In one embodiment, a lifting apparatus includes a lifting plate on which an injection apparatus is mounted and a drive unit configured to move the lifting plate up and down relative to a base. The drive unit includes a feed screw made up of a screw shaft fixed to the base and a nut which supports the lifting plate and moves up and down integrally with the lifting plate while rotating.

### CROSS REFERENCES TO RELATED APPLICATIONS

The present application claims priority to Japanese Patent Application No. 2024-083284 filed on May 22, 2024, the disclosure of which is incorporated herein by reference.

### TECHNICAL FIELD

This disclosure relates to a lifting apparatus and an injection molding machine.

### BACKGROUND

An injection molding machine made up of a mold clamping apparatus to which a molding die is attached and an injection apparatus configured to supply a molding material to the molding die attached to the mold clamping apparatus is known. In addition, an injection molding machine in which a vertical mold clamping apparatus and a horizontal injection apparatus are combined is known as an example of an injection molding machine.

Japanese Unexamined Patent Application Publication No. 2010-280059 (Patent Document 1) discloses a lifting mechanism configured to move a horizontal injection apparatus combined with a vertical mold clamping apparatus up and down relative to a base. The lifting mechanism disclosed in Patent Document 1 is made up of a servo motor, a ball screw, a ball nut, and the like.

### SUMMARY

The mechanism and apparatus configured to move an injection apparatus up and down relative to a base may be a factor that restricts the shape and dimensions of the base.

According to this disclosure, a lifting apparatus according to one embodiment includes a drive unit configured to move a lifting plate, on which an injection apparatus is mounted, up and down relative to a base. This drive unit includes a feed screw made up of a screw shaft fixed to the base and a nut which supports the lifting plate and moves up and down integrally with the lifting plate while rotating.

According to this disclosure, the restriction on the size and dimensions of the base of the injection molding machine can be alleviated.

### BRIEF DESCRIPTION OF DRAWINGS

FIG. 1 is a side view schematically illustrating an operation side of an injection molding machine according to one embodiment.

FIG. 2 is a side view illustrating a comparison between a state in which a lifting plate illustrated in FIG. 1 is lowered to a lower limit position and a state in which it is lifted to an upper limit position.

FIG. 3 is a front view illustrating the comparison between the state in which the lifting plate illustrated in FIG. 1 is lowered to the lower limit position and the state in which it is lifted to the upper limit position.

FIG. 4 is a plan view illustrating a structure of a lifting apparatus according to one embodiment.

FIG. 5 is a bottom view illustrating the structure of the lifting apparatus according to one embodiment.

FIG. 6 is a side view illustrating the structure of the lifting apparatus according to one embodiment.

FIG. 7 is an enlarged cross-sectional view taken along the line A-A in FIG. 4.

FIG. 8A is a side view schematically illustrating a lifting apparatus as a comparative example.

FIG. 8B is a front view schematically illustrating the lifting apparatus as the comparative example.

### DETAILED DESCRIPTION OF THE INVENTION

An embodiment will be described below with reference to drawings. Note that the same or substantially the same configurations and elements are denoted by the same reference characters in all the drawings for describing the embodiment. Also, the descriptions of the configurations and elements that have been once described will not be repeated in principle.

### Outline of Injection Molding Machine

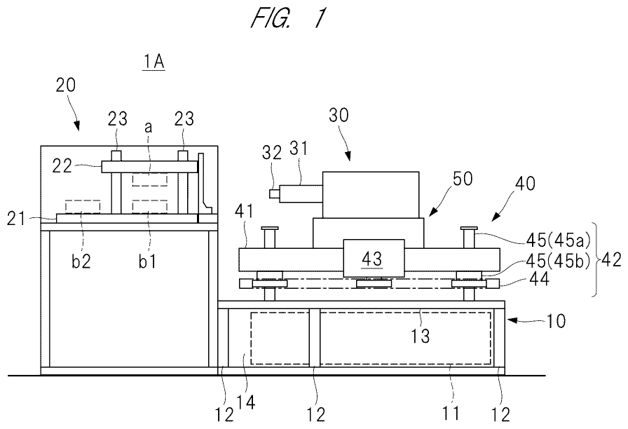

FIG. 1 is a side view schematically illustrating an operation side of an injection molding machine 1A according to the present embodiment. The injection molding machine 1A includes a base 10, a mold clamping apparatus 20, an injection apparatus 30, a lifting apparatus 40, and a moving apparatus 50.

The base 10 is a seat on which the mold clamping apparatus 20, the injection apparatus 30, and others constituting the injection molding machine 1A are mounted, and is generally referred to as a “bed.” Therefore, in the following description, the base 10 may be referred to as the “bed 10.”

A control panel 11 for controlling the injection apparatus 30 and others is provided inside the bed 10. From another perspective, a controller configured to control the injection apparatus 30 and others is provided inside the bed 10.

At least a part of the bed 10 on which the injection apparatus 30, the lifting apparatus 40, and the moving apparatus 50 are mounted is made up of a plurality of frames 12 and a top plate 13 supported by these frames 12, and is lower than another part of the bed 10 on which the mold clamping apparatus 20 is mounted. The top plate 13 has an approximately rectangular planar shape and has an area capable of mounting the lifting apparatus 40.

The top plate 13 is supported from below by the plurality of frames 12 arranged on a peripheral edge thereof. In other words, the frames 12 are pillars that support the top plate 13. The control panel 11 is arranged in a space 14 located on an inner side of the plurality of frames 12 and below the top plate 13.

The mold clamping apparatus 20, the injection apparatus 30, the lifting apparatus 40, and the moving apparatus 50 perform various operations under the comprehensive control by the control panel 11. For example, the mold clamping apparatus 20 performs the die opening/closing, the mold clamping, and others based on the control by the control panel 11. Also, the injection apparatus 30 performs measurement and injection of a molding material based on the control by the control panel 11.

### Mold Clamping Apparatus

The mold clamping apparatus 20 includes a turntable 21 and an upper movable platen 22 facing each other in an up-down direction. Though not illustrated, a fixed platen is provided under the turntable 21, and a lower movable platen is provided under the fixed platen.

The upper movable platen 22 and the lower movable platen are connected to each other by tie bars 23 penetrating through the turntable 21 and the fixed platen. Furthermore, a mold clamping mechanism is provided between the fixed platen and the lower movable platen.

A plurality of molding dies can be attached to the mold clamping apparatus 20. In the present embodiment, two lower molding dies b1 and b2 are attached to an upper surface of the turntable 21, and one upper molding die a is attached to a lower surface of the upper movable platen 22. Note that the two lower molding dies b1 and b2 are attached at positions different by 180 degrees in a rotation direction of the turntable 21.

The turntable 21 can rotate ±180 degrees. Therefore, by rotating the turntable 21, the lower molding die b1 or the lower molding die b2 can be selectively made to face the upper molding die a.

From another perspective, by rotating the turntable 21 180 degrees, the lower molding die that faces the upper molding die a can be switched. In other words, by rotating the turntable 21 180 degrees, the combination of the upper and lower molding dies can be changed.

The upper movable platen 22 is driven up and down by a die opening and closing mechanism. At this time, the tie bars 23 guide the up-down movement (ascending and descending) of the upper movable platen 22. When the upper movable platen 22 descends, the upper molding die a attached to the upper movable platen 22 is butted against the lower molding die b1 or the lower molding die b2 attached to the turntable 21. Namely, the upper and lower molding dies are closed.

Meanwhile, when the upper movable platen 22 ascends, the upper molding die a attached to the upper movable platen 22 moves away from the lower molding die b1 or the lower molding die b2 attached to the turntable 21. In other words, the upper and lower molding dies are opened.

As described above, the mold clamping apparatus 20 according to the present embodiment performs the die opening/closing in the up-down direction (vertical direction). In other words, the mold clamping apparatus 20 according to the present embodiment is a vertical mold clamping apparatus particularly suitable for the multi-material molding and the insert molding.

Therefore, the injection molding machine 1A according to the present embodiment provided with the mold clamping apparatus 20 is suitable for the multi-material molding and the insert molding. Understandably, the molding performed by the injection molding machine 1A is not limited to the multi-material molding and the insert molding.

### Injection Apparatus

The injection apparatus 30 supplies a molding material to the molding die attached to the mold clamping apparatus 20. More specifically, the injection apparatus 30 includes a heating cylinder 31 to which a raw material of the molding material is supplied. The heating cylinder 31 is horizontally arranged, and an axis thereof with a die opening/closing intersects (orthogonally) direction in the mold clamping apparatus 20.

Here, the axial direction (longitudinal direction) of the heating cylinder 31 is defined as a “front-back direction.” Also, the side where the mold clamping apparatus 20 is arranged is defined as a “front side (forward)”, and the opposite side thereof is defined as a “back side (backward).” Understandably, such definitions are merely for the convenience of description.

The heading cylinder 31 heats and melts the supplied raw material. In the present embodiment, resin pellets are supplied into the heating cylinder 31 to be melted. A screw is provided inside the heating cylinder 31. The molten resin pellets (molten resin) are kneaded by the rotating screw.

The kneaded molten resin is extruded by the screw from the heating cylinder 31. More specifically, the molten resin is pushed by the screw moving forward and is injected from a nozzle 32 provided at a tip end of the heating cylinder 31.

As described above, the injection apparatus 30 according to the present embodiment includes the heating cylinder 31 arranged horizontally and supplies a molding material to the molding die attached to the mold clamping apparatus 20 from a lateral side. Namely, the injection apparatus 30 according to the present embodiment is a horizontal injection apparatus suitable for the installation in locations with low ceilings.

As described above, the mold clamping apparatus 20 according to the present embodiment is a vertical mold clamping apparatus. Namely, the injection molding machine 1A according to the present embodiment is an injection molding machine in which a vertical mold clamping apparatus and a horizontal injection apparatus are combined. In other words, the injection molding machine 1A is a “vertical mold clamping/horizontal Therefore, the injection injection molding machine.” molding machine 1A has both the advantage of the vertical mold clamping apparatus and the advantage of the horizontal injection apparatus.

### Lifting Apparatus

The lifting apparatus 40 includes a lifting plate 41 and a drive unit 42. The lifting plate 41 is moved up and down relative to the bed 10 by the drive unit 42. When the lifting plate 41 is moved up and down relative to the bed 10, the injection apparatus 30 mounted on the lifting plate 41 is also moved up and down relative to the bed 10.

From another perspective, height the the of injection apparatus 30 can be adjusted by the lifting apparatus 40. For example, by adjusting the height of the injection apparatus 30 by the lifting apparatus 40, the position (height) of the nozzle 32 can be aligned with the position (height) of a sprue bush of the molding die.

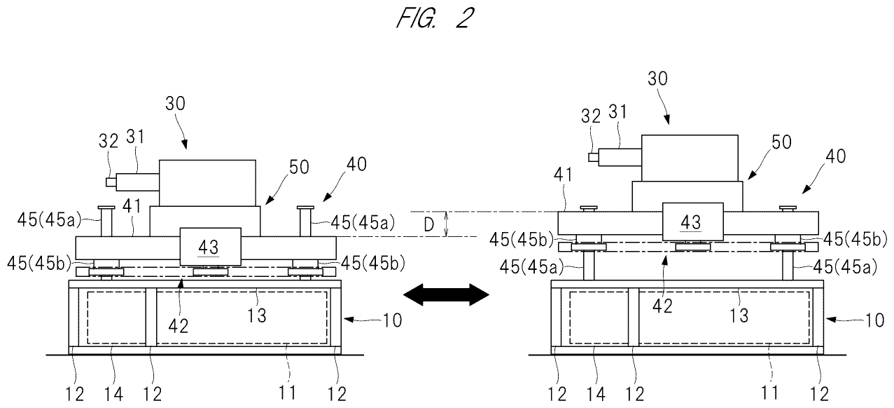

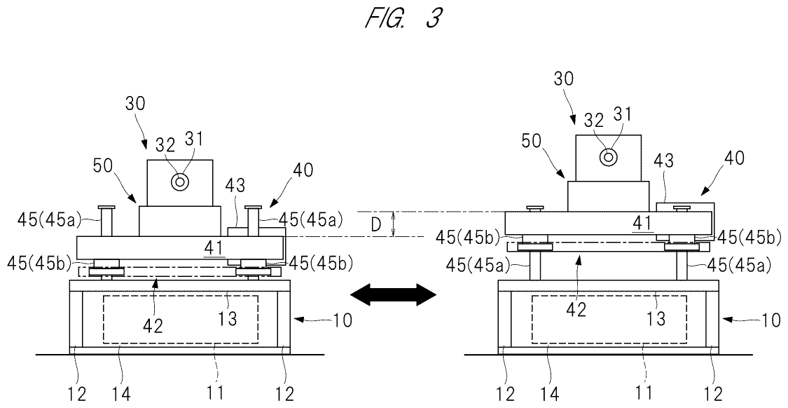

FIG. 2 is a side view illustrating a comparison between a state in which the lifting plate 41 is lowered to a lower limit position and a state in which the lifting plate 41 is lifted to an upper limit position. FIG. 3 is a front view illustrating the comparison between the state in which the lifting plate 41 is lowered to the lower limit position and the state in which the lifting plate 41 is lifted to the upper limit position.

The lifting plate 41 on which the injection apparatus 30 is mounted moves up and down between the lower limit position illustrated on the left side in FIG. 2 and FIG. 3 and the upper limit position illustrated on the right side in FIG. 2 and FIG. 3. Note that a height difference D between the lower limit position and the upper limit position illustrated in the drawings is 65 mm. In other words, a lifting stroke of the lifting plate 41 is 65 mm. From another perspective, the lifting apparatus 40 can lift the injection apparatus 30 by 65 mm.

### Lifting Plate

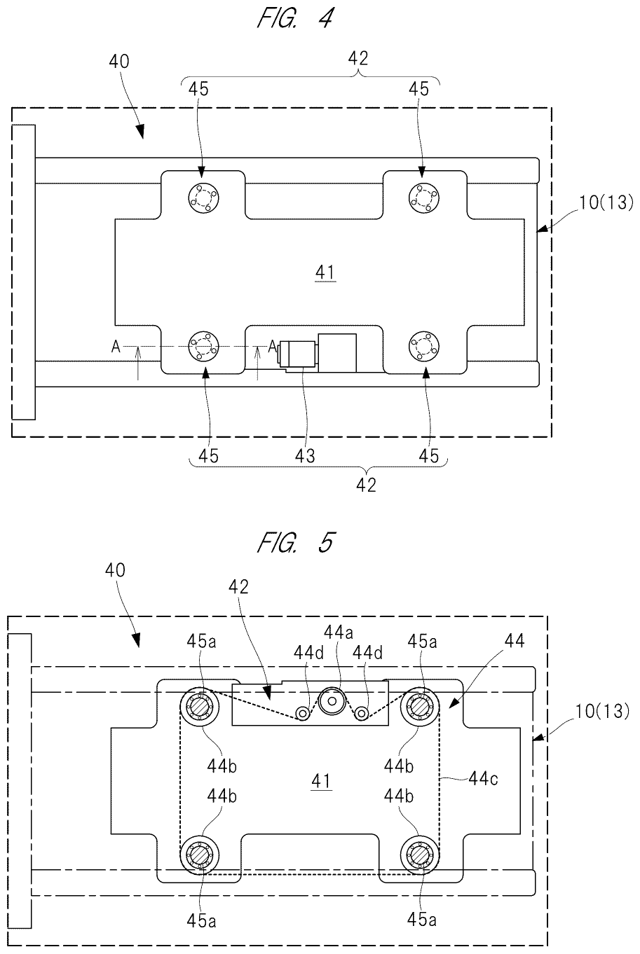

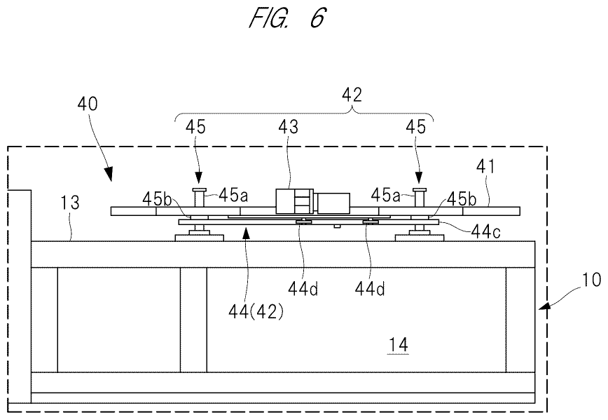

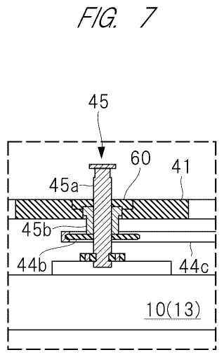

FIG. 4 is a plan view illustrating a structure of the lifting apparatus 40, FIG. 5 is a bottom view thereof, and FIG. 6 is a side view thereof. Also, FIG. 7 is an enlarged cross-sectional view taken along the line A-A in FIG. 4.

The lifting plate 41 is arranged on the bed 10. Though not illustrated in FIG. 4 to FIG. 6, the injection apparatus 30 is mounted on the lifting plate 41 as described above. More specifically, the moving apparatus 50 is mounted on the lifting plate 41, and the injection apparatus 30 is mounted on the moving apparatus 50 (see FIG. 1).

The lifting apparatus 40 moves the lifting plate 41, on which the moving apparatus 50 and the injection apparatus 30 are mounted, up and down relative to the bed 10. From another perspective, the lifting plate 41 is a movable stage configured to move up and down with the moving apparatus 50 and the injection apparatus 30 mounted thereon.

### Drive Unit

The drive unit 42 configured to move the lifting plate 41 up and down includes a drive source 43, a power transmission mechanism 44, and a feed screw 45. The drive source 43 is a geared motor and is provided in the lifting plate 41. More specifically, the drive source 43 is arranged on an operation side at the center or approximately the center of the lifting plate 41 in the longitudinal direction.

The drive unit 42 includes a plurality of feed screws 45. More specifically, the drive unit 42 includes four feed screws 45, and each of the feed screws 45 is made up of a screw shaft 45a and a nut 45b. Two feed screws 45 are arranged on the operation side of the lifting plate 41 and the other two feed screws 45 are arranged on a non-operation side of the lifting plate 41.

The screw shaft 45a of each feed screw 45 is provided on the bed 10 so as to be unable to move. More specifically, one end (lower end) of the screw shaft 45a of each feed screw 45 is fixed to the top plate 13 of the bed 10. From another perspective, the screw shaft 45a of each feed screw 45 extends vertically upward from the top plate 13 of the bed 10.

The nut 45b of each feed screw 45 is screwed to each screw shaft 45a. Further, a part of the screw shaft 45a protruding from the nut 45b is inserted into the lifting plate 41. As a result, the lifting plate 41 is supported from below by the nut 45b of each feed screw 45.

More specifically, as illustrated in FIG. 7, an annular lid member 60 is fitted into an inner side of a through hole formed in the lifting plate 41. A part of the screw shaft 45a protruding from the nut 45b penetrates through the lid member 60 and protrudes from the lifting plate 41. As a result, an upper surface of the nut 45b of each feed screw 45 is in contact with a lower surface of the lid member 60.

From another perspective, each nut 45b supports the lifting plate 41 via the lid member 60. In other words, the lifting plate 41 is placed on the four nuts 45b. Therefore, when the nuts 45b are rotated to move the nuts 45b in an axial direction of the screw shaft 45a, the lifting plate 41 moves up and down relative to the bed 10.

Note that the upper surface of the nut 45b may be made into direct contact with a periphery of the through hole formed in the lifting plate 41 by omitting the lid member 60.

As mainly illustrated in FIG. 5, the power transmission mechanism 44 includes a drive sprocket 44a, driven sprockets 44b, and a roller chain 44c. The drive sprocket 44a is fixed to an output shaft of the drive source 43 and is driven to rotate by the drive source 43. The driven sprockets 44b are each fixed to a lower surface of the nut 45b of the feed screw 45 by a bolt. From another perspective, the nut 45b and the driven sprocket 44b are integrated with each other.

The roller chain 44c is looped around the drive sprocket 44a and the four driven sprockets 44b. As a result, the driving force output from the drive source 43 is transmitted to the nut 45b of each feed screw 45 via the power transmission mechanism 44, so that the nuts 45b are rotated.

Note that idler sprockets (tension sprockets) 44d for applying a proper tension to the roller chain 44c are arranged on both sides of the drive sprocket 44a. Also, by releasing the fixation by the bolt, the nut 45b and the driven sprocket 44b can be separated from each other. Further, by detaching the lid member 60 illustrated in FIG. 7 from the lifting plate 41, the nut 45b from which the driven sprocket 44b has been separated can be taken out above the lifting plate 41.

### Moving Apparatus

Refer to FIG. 1 again. The moving apparatus 50 can move the injection apparatus 30 forward and backward on the lifting plate 41. More specifically, the moving apparatus 50 can move the injection apparatus 30 in a direction approaching the mold clamping apparatus 20 (forward direction) and a direction away from the mold clamping apparatus 20 (backward direction).

The moving apparatus 50 includes a pair of cylinders. The moving apparatus 50 extends a rod of each cylinder to move the injection apparatus 30 backward and contracts the rod of each cylinder to move the injection apparatus 30 forward.

Understandably, the relationship between the extension and contraction of the rod and the moving direction of the injection apparatus 30 may be reverse to that described above. In other words, in another embodiment, the injection apparatus 30 moves forward when the rod of the cylinder extends and the injection apparatus 30 moves backward when the rod of the cylinder contracts. Note that the cylinder may be a hydraulic cylinder or an air cylinder. Also, the cylinder may be replaced with another actuator.

### Gist

As described above, in the present embodiment, the nuts 45b of the feed screws 45, the drive source 43, and the power transmission mechanism 44 move up and down integrally with the lifting plate 41. On the other hand, the screw shafts 45a of the feed screws 45 are fixed to the bed 10 and do not move and rotate. From another perspective, the screw shafts 45a do not protrude into the space 14 below the top plate 13. Therefore, there is no risk of the screw shafts 45a coming into contact with the control panel 11 in the space 14.

As a result, according to the present embodiment, it is not necessary to take into consideration the interference between the screw shaft 45a and the control panel 11 when designing the shape and dimensions of the bed 10, and the degree of freedom in designing the bed 10 is improved. More specifically, it is possible to reduce the size and lower the height of the bed 10 by reducing the height and width of the bed 10.

### Comparative Example

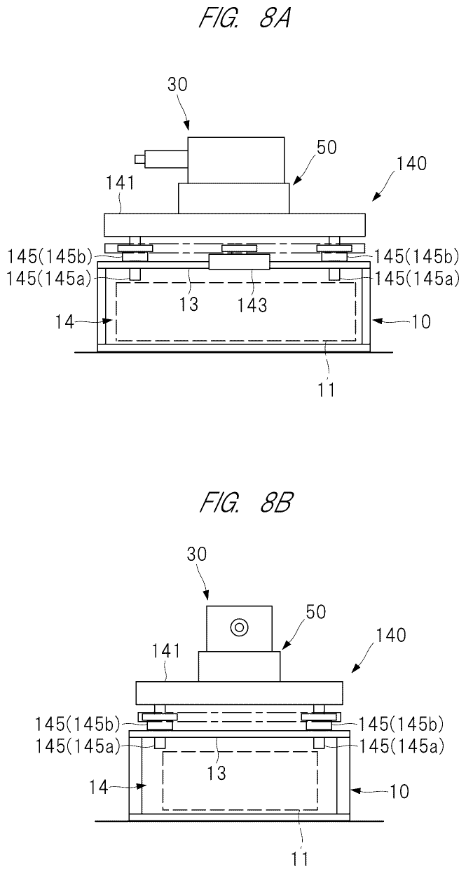

FIG. 8A is a side view schematically illustrating a lifting apparatus 140 as a comparative example. FIG. 8B is a front view schematically illustrating the lifting apparatus 140 as the comparative example. The lifting apparatus 140 moves a lifting plate 141 up and down relative to the bed 10 by feed screws 145 like the lifting apparatus 40 according to the present embodiment.

However, in the lifting apparatus 140, upper ends of screw shafts 145a are fixed to the lifting plate 141, and nuts 145b are rotatably provided on the bed 10. Then, when the nuts 145b are driven to rotate by a drive source 143 also provided on the bed 10, the screw shafts 145a move up and down, whereby the lifting plate 141 moves up and down.

In the lifting apparatus 140, the screw shafts 145a penetrate through the top plate 13 of the bed 10 and protrude into the space 14 below the top plate 13. Therefore, there is a risk of the screw shafts 145a coming into contact with the control panel 11 in the space 14. Accordingly, when using the lifting apparatus 140, it is necessary to design the shape and dimensions of the bed 10 such that the screw shafts 145a and the control panel 11 do not come into contact with each other. As a result, the height and width of the bed 10 will increase, or the shape of the bed 10 will be restricted.

The present invention is not limited to the above-mentioned embodiments, and various modifications are possible within the range not departing from the scope of the present invention. For example, the mold clamping apparatus 20 is not limited to a vertical mold clamping apparatus, and the injection apparatus 30 is not limited to a horizontal injection apparatus. The sprockets 44a and 44b constituting the power transmission mechanism 44 of the lifting apparatus 40 can be replaced with pulleys, and the roller chain 44c can be replaced with a belt, respectively.

What is claimed is:

1. A lifting apparatus comprising:
a lifting plate which is arranged on a base of an injection molding machine and on which an injection apparatus is mounted; and
a drive unit including a feed screw and configured to move the lifting plate up and down relative to the base,
wherein a screw shaft constituting the feed screw is fixed to the base, and
wherein a nut constituting the feed screw supports the lifting plate and moves up and down integrally with the lifting plate while rotating.

2. The lifting apparatus according to claim 1,
wherein the drive unit includes a drive source and a power transmission mechanism configured to transmit a driving force output from the drive source to the nut, and
wherein the drive source and the power transmission mechanism are provided on the lifting plate and move up and down integrally with the lifting plate.

3. The lifting apparatus according to claim 2,
wherein the drive unit includes a plurality of feed screws each equivalent to the feed screw, and
wherein the driving force output from the drive source is transmitted to the nut of each of the feed screws via the power transmission mechanism.

4. The lifting apparatus according to claim 3,
wherein the power transmission mechanism includes:
a drive sprocket driven to rotate by the drive source;
a driven sprocket provided on each of the nuts; and
a roller chain looped around the drive sprocket and the driven sprockets.

5. An injection molding machine comprising:
a mold clamping apparatus to which a molding die can be attached;
an injection apparatus configured to supply a molding material to the molding die attached to the mold clamping apparatus; and
a lifting apparatus capable of moving the injection apparatus in an up-down direction,
wherein the lifting apparatus includes a lifting plate which is arranged on a base and on which the injection apparatus is mounted and a drive unit including a feed screw and configured to move the lifting plate up and down relative to the base,
wherein a screw shaft constituting the feed screw is fixed to the base, and
wherein a nut constituting the feed screw supports the lifting plate and moves up and down integrally with the lifting plate while rotating.

6. The injection molding machine according to claim 5, further comprising a moving apparatus interposed between the lifting apparatus and the injection apparatus,
wherein the moving apparatus can move the injection apparatus on the lifting plate in a direction approaching the mold clamping apparatus and a direction away from the mold clamping apparatus.

7. The injection molding machine according to claim 5,
wherein the mold clamping apparatus is a vertical mold clamping apparatus and the injection apparatus is a horizontal injection apparatus.
